(19) United States
(12) Patent Application Publication
(10) Pub. No.: US 2020/0012960 A1
(43) Pub. Date: Jan. 9, 2020

(54) METHOD AND SERVER FOR PROVIDING PROBABILITY OF ENCOUNTERING OTHER PEOPLE

(71) Applicant: HANDS CORP., Gwangju-si Gyeonggi-do (KR)

(72) Inventor: Seok Hyeon KIM, Gwangju-si (KR)

(73) Assignee: HANDS CORP., Gwangju-si Gyeonggi-do (KR)

(21) Appl. No.: 16/491,534

(22) PCT Filed: Mar. 12, 2018
(86) PCT No.: PCT/KR2018/002888

§ 371 Date: Sep. 5, 2019

(30) Foreign Application Priority Data
Mar. 16, 2017 (KR) 10-2017-0033252

(51) Int. Cl. G06N 7/00; G06F 16/951; G06Q 50/00

(52) U.S. Cl. CPC G06N 7/005; G06Q 50/01; G06F 16/951

(57) ABSTRACT

The present invention relates to a method and server for providing a probability of encountering other people and, more specifically, to a technique for calculating a probability of an encounter between a user and any other user by analyzing information provided by the users. The server for providing a probability of encountering other people according to the present invention comprises: a user information database unit for storing event information provided by two or more users; a schedule analysis unit for analyzing event information and extracting time information and space information of each of the users according to an information extracting algorithm so as to generate probability factor information; and a probability calculation unit for determining the degree of overlapping between the user probability factor information of each two users so as to calculate the probability that the two users encounter each other.

### TECHNICAL FIELD

The present invention relates to a method and a server for providing a probability of encountering other people, and more specifically, to a technique for calculating a probability of an encounter between one user and another user by analyzing information provided from the users.

### BACKGROUND ART

A social networking service (hereinafter referred to as “SNS”) refers to an online platform that creates and strengthens social relations through free communication and information sharing between users, expansion of personal connections, and the like. The most important part of the SNS is that a social relation network is created, maintained, strengthened, and expanded through the service. It may be more meaningful when information is shared and circulated through the relation network.

Due to an increase in the number of smartphone users and expansion of wireless Internet services, the number of SNS users has been rapidly increasing. In particular, the number of users of Facebook and Twitter, which are leading an SNS market in Korea, has already exceeded 10 million in 2011, and it is expected that such a trend of increasing the users may be continued for a time.

SNSs that are popular recently have been increasing the number of users with their own unique and competitive services. In detail, Facebook provides a function of recommending and displaying a person who may be acquainted with a user, Twitter provides a function of instantly transmitting a short message of a user to other users who follow the user, and Instagram provides a function of sharing photographs with other people based on specific interests.

US Patent Application Publication No. 2011/0145719 discloses a technique for recommending a friend among SNS users, like a distinguishing service of Facebook. In addition, US Patent Publication No. 8401009 discloses a technique for a message distribution platform that transmits a message uploaded by one user to a plurality of other users, like a distinguishing service of Twitter.

As such, each of the SNSs always has needs to develop a unique service in order to increase the competitiveness for acquiring subscribers, and thus has been making great efforts to develop such technologies.

### DETAILED DESCRIPTION OF THE INVENTION

### Technical Problem

The present invention aims to provide a novel and competitive technology differentiated from the above-described conventional SNS, in which information provided from users is analyzed to calculate a probability of an encounter with other people, so that a new online social relation network may be created, maintained, strengthened, and expanded.

### Technical Solution

In order to achieve the above object, a server for providing a probability of encountering other people includes: a user information database unit for storing at least one of a text, a photograph, and a video uploaded to an SNS system as event information for each user in association with the SNS system; a schedule analysis unit for analyzing the event information to extract a target place of each user, a date, an arrival time zone for the place, and a stay time at the place according to an information extracting algorithm so as to generate probability factor information; and a probability calculation unit for calculating an encountering probability among users by determining an overlapping degree of the probability factor information of the users. According to one aspect of the present invention, the event information may include at least one of text information, image information, and video information.

According to another aspect of the present invention, when the event information is denormalized text information, the schedule analysis unit may divide the denormalized text information in a unit of a predetermined size of strings or words to extract a sequence value for each unit, and may analyze each of the extracted sequence values to assign a result of the analysis as the probability factor information.

According to still another aspect of the present invention, when the event information is the image information or the video information, the schedule analysis unit may analyze metadata included in the image information or the video information to extract at least one of capturing date information, capturing time information, and capturing location information so as to assign a result of the extraction as the probability factor information.

According to yet another aspect of the present invention, when pieces of the probability factor information of the users about the place and the date are identical to each other, the probability calculation unit may calculate the encountering probability among the users by analyzing geometrically-overlapping regions by using the arrival time zone and the stay time of each user.

Meanwhile, in order to achieve the above object, the present invention provides a server for providing a probability of encountering other people, the server including: a user information database unit for storing basic information provided to an SNS system in association with the SNS system; a schedule analysis unit for analyzing the basic information to extract regular time information and regular space information of each user according to an information extracting algorithm so as to generate probability factor information; and a probability calculation unit for calculating an encountering probability between two users by determining an overlapping degree of the probability factor information of the two users, wherein the basic information includes information on two places which are target places to go repeatedly at least two times within a predetermined period of time, departure/arrival time information, and transportation information.

According to one aspect of the present invention, the schedule analysis unit may analyze the basic information to generate the probability factor information in terms of the place, the date, the arrival time zone, and the stay time, and may estimate the arrival time zone and the stay time based on the transportation information included in the basic information.

According to another aspect of the present invention, when pieces of the probability factor information of the users about the place and the date are identical to each other, the probability calculation unit may calculate the encountering probability among the users by analyzing geometrically-overlapping regions by using the arrival time zone and the stay time of each user.

In order to achieve the above object, a server for providing a probability of encountering other people includes: a user information database unit for storing at least one of a text, a photograph, and a video uploaded to an SNS system as event information for each user in association with the SNS system, and storing basic information provided from a user terminal for each user; a schedule analysis unit for analyzing the event information to extract a target place of each user, a date, an arrival time zone for the place, and a stay time at the place in a past according to an information extracting algorithm so as to generate probability factor information, or analyzing the basic information to extract a target place of each user, a date, an arrival time zone for the place, and a stay time at the place in a future according to the information extracting algorithm so as to generate the probability factor information; and a probability calculation unit for calculating an encountering probability among users in the past by determining an overlapping degree of the probability factor information generated based on the event information of the users, or calculating an encountering probability among users in the future by determining an overlapping degree of the probability factor information generated based on the basic information of the users, wherein the basic information includes information about a daily life pattern of each user that occurs regularly.

### Advantageous Effects of the Invention

According to the present invention, unlike the conventional SNS that provides a service to form a social relation network with acquaintances or personal connections derived from the acquaintances, the social relation network can be formed with people close to a user in time and space, including the acquaintances and the derived personal connections.

In addition, according to the present invention, unlike the existing SNS, it is possible to bring about creation, expansion, strengthening, and maintenance of social relations in a new field of interest, and furthermore, alternatives to social opinion formation, expansion of information exchange means, global relation, sharing, communication, cooperation, and the like can be achieved.

In addition to the effects of the present invention as described above, other effects may be further mentioned in the following description.

### DESCRIPTION OF THE DRAWINGS

FIG. 1 is a schematic view showing a probability analysis server for providing a probability of encountering other people and an SNS network system interworking with the probability analysis server according to an embodiment of the present invention.

FIG. 2 is a view showing a detailed configuration of the probability analysis server according to the embodiment of the present invention.

FIG. 3 is a flowchart showing processes of a method for providing a probability of encountering other people according to an embodiment of the present invention.

FIG. 4 is a flowchart showing a process of deriving the probability of encountering other people by using event information according to an embodiment of the present invention.

FIG. 5 is a flowchart showing a process of deriving the probability of encountering other people by using basic information of a user according to another embodiment of the present invention.

FIG. 6 is a flowchart showing a detailed process of calculating the probability of encountering other people according to an embodiment of the present invention.

FIG. 7 is a flowchart showing a detailed process of geometrically calculating the probability of encountering other people according to an embodiment of the present invention.

FIG. 8 is a flowchart showing a detailed process of geometrically calculating the probability of encountering other people according to another embodiment of the present invention.

### BEST MODE

Hereinafter, embodiments of the present invention will be described in detail with reference to the accompanying drawings. However, the embodiments set forth herein are provided so that a person with ordinary skill in the art to which the present invention pertains may easily embody the present invention. Thus, the protection scope of the present invention is not construed as being limited to the embodiments. Further, in describing various embodiments of the present invention, like reference numerals denote elements having identical technical features.

Although an illustrative implementation of at least one embodiment is provided below, it is to be understood at the outset that the disclosed systems, apparatuses, and/or methods may be implemented using any number of techniques, whether currently known or in existence. The present disclosure should by no means be limited to the illustrative implementations, drawings, and techniques illustrated below, including the exemplary designs and implementations illustrated and described herein, but may be modified within the scope of the appended claims along with their full scope of equivalents. While certain aspects of conventional technologies have been discussed to facilitate the present disclosure, the applicant by no means disclaims these technical aspects, and the present disclosure may encompass at least one of the conventional technical aspects discussed herein.

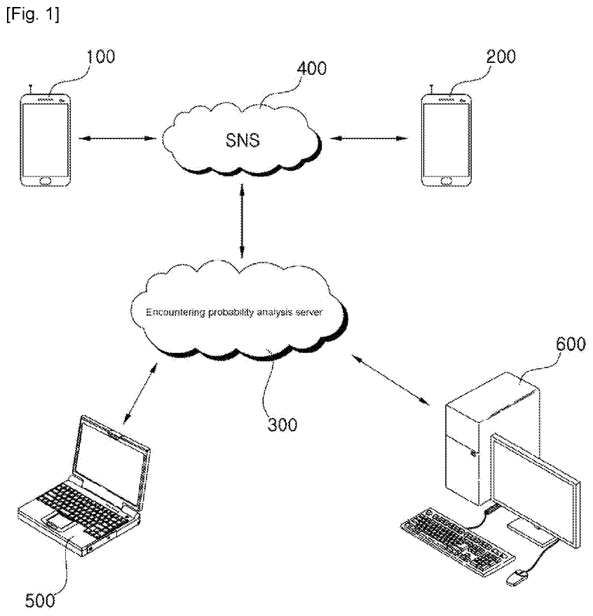

FIG. 1 is a schematic view showing a probability analysis server for providing a probability of encountering other people and an SNS interworking with the probability analysis server according to an embodiment of the present invention.

A probability analysis server 300 for providing a probability of encountering other people according to the embodiment of the present invention may receive event information from two or more users 100, 200, 500, and 600 to calculate the encountering probability based on the event information so as to transmit information on the calculated encountering probability to the users 100, 200, 500, and 600. In this case, the users may use any electronic device that may use an SNS and provide the event information and receive the probability information through an online network, such as smart mobile devices 100 and 200, a laptop computer 500, and a desktop computer 600.

The probability analysis server 300 may interwork with an SNS system 400 in which users access to upload and record event information such as a text, a photograph, and a video and to share the recorded event information with other users, so that the probability analysis server 300 may collect the event information provided by multiple users to calculate the encountering probability based on time information and space information analyzed from the event information of the users.

In this case, the SNS 400 may be operated by the same service provider as the probability analysis server 300, and may interwork with other SNSs on the market, such as Facebook, Twitter, and Instagram, to receive the event information from other SNSs and provide a service experience for the calculation of the encountering probability to the users through other SNSs on the market.

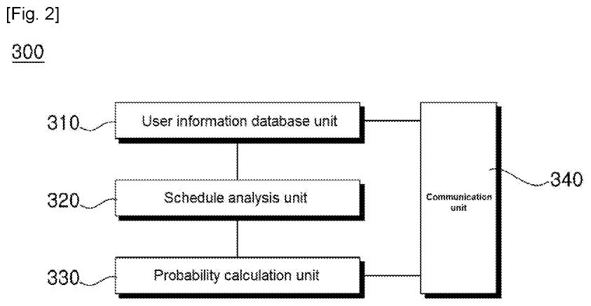

Hereinafter, the detailed configuration and the detailed operation principle of the probability analysis server for providing the probability of encountering other people will be described in detail with reference to FIGS. 2 to 8.

FIG. 2 is a view showing a detailed configuration of the probability analysis server according to the embodiment of the present invention.

According to the embodiment of the present invention, the probability analysis server 300 may include a user information database unit 310, a schedule analysis unit 320, a probability calculation unit 330, and a communication unit 340.

The user information database unit 310 may store the event information provided from the users through the communication unit 340 for each user. In this case, the event information refers to text information such as letters and numbers, image information such as photographs, and video information shared with other people by the users through the SNS. For example, SNS users may go to a famous restaurant, take photographs of foods ordered at the restaurant or take photographs or videos with a companion by using a smart device, and add the text information to upload resulting contents to the SNS. The information provided to SNS as described above is a representative example of the event information.

Meanwhile, the event information may further include schedule information such as appointments with friends and business meetings. Recently, mobile devices provide a dedicated scheduler application to conveniently manage a schedule of a user, and the application may interwork with the SNS to provide schedule information of the user to the user information database unit 310.

In addition, the user information database unit 310 may store basic information provided from the users through the communication unit 340 for each user in addition to the event information.

The basic information refers to information about a daily life pattern of the user. For example, the basic information may include information that may be applied to the user on a daily basis, such as a home address, a company name, a company address, a work department, a commuting time, a commuting method, a school name, an academic department, a school commuting time, and a school commuting method. The basic information may also be interpreted as event information that occurs repeatedly at least two times within a predetermined period of time, and may be referred to as event information that occurs frequently or regularly relative to the event information of the present invention.

Meanwhile, the user information database unit 310 may be operated in the form of a web server, a web service, or a database, and the communication unit 340 may transmit and receive information to and from the user information database unit 310 by using data transmission protocols such as SOAP, RESTful, Socket, HTTP, HTTPS, FTP, and JMS.

The schedule analysis unit 320 may analyze the event information or the basic information stored in the user information database unit 310 to extract the time information and the space information of each user according to an information extracting algorithm so as to generate probability factor information. In this case, the probability factor information refers to a calculation factor required for calculating an encountering probability between at least two people, and may be classified into a place (hereinafter referred to as “AR”), a date (hereinafter referred to as “DA”), an arrival time zone (hereinafter referred to as “AT”), and a stay time (hereinafter referred to as “ST”).

The event information or the basic information may be generally classified into a case in which the event information or the basic information is created as a normalized type and a case in which the event information or the basic information is created as a denormalized type. The process of generating the probability factor information according to each case will be described as follows.

When the event information or the basic information is created as the normalized type, the schedule analysis unit 320 may analyze a designated format to classify and assign each of the probability factor information. For normalized data, AR, DA, AT, and ST information may be input using a normalized form for inputting schedules. In this case, since the meaning of the information is clear, the probability can be calculated by substituting each factor without applying an additional algorithm for extracting the information.

When the event information or the basic information is created as a denormalized text type, the schedule analysis unit 320 may divide denormalized text information in a unit of a predetermined size of strings or words to extract a sequence value for each unit, and may analyze each of the extracted sequence values to assign a result of the analysis as the probability factor information.

Input data of the event information or the basic information may be input in free sentences including letters and numbers. In this case, the probability factor information may be extracted using the information extracting algorithm and a database created in advance about a place, a date, and a time. In this case, the following algorithm may be used as one example of the information extracting algorithm.

The schedule analysis unit 320 may extract a value of a sequence set while moving from left to right by a unit of n strings or a unit of a size of words, wherein n is an index indicating a unit by which the information is to be cut. For example, in the case where the input data is “Feb. 15, 2017, Seoul National University, First Schoolyard, 2:00˜3:00, Cheering Practice”, when the input data is extracted by a unit of one word, “2017”, “February”, “15”, “Seoul National University”, “First Schoolyard”, “2:00˜3:00”, “Cheering”, and “Practice” may be extracted. The extracted values may be compared with values stored in place, date, and time databases, and each of the values may be classified into AR, DA, AT, and ST factors so as to be assigned thereto.

In this case, “2017”, “February”, and “15” among the extracted information are values that exist in the date database, but do not exist in the place and time databases. Therefore, “Feb. 15, 2017” may be classified as DA. In addition, “Seoul National University” and “First Schoolyard” among the extracted information are values that do not exist in the date and time databases, but exist in the place database. Therefore, “Seoul National University First Schoolyard” may be classified as AR.

In addition, “2:00˜3:00” among the extracted information is a value that exists only in the time database, but not in the place and date databases. In addition, when two numbers exist in a single extracted value without being arranged consecutively, it means that the information contains numbers with two meanings. In this case, a value obtained by subtracting a small number from a large number among the numbers may be classified as ST, and ±10 minutes from the small number may be classified as AT. Since slightly early arrival or slightly late arrival may generally occur with respect to the arrival time, AT may be a value in the range of ±10 minutes. In other words, in “2:00˜3:00”, AT may be 1:50˜2:10, and ST may be 1 hour (60 minutes). In summary, when the probability factor is extracted from the denormalized data “Feb. 15, 2017, Seoul National University, First Schoolyard, 2:00˜3:00, Cheering Practice” by using the information extracting algorithm and the databases generated in advance, DA may be “Feb. 15, 2017”, AR may be “Seoul National University First Schoolyard”, AT may be “1:50˜2:10”, and ST may be “1 hour (60 minutes)”.

Meanwhile, when ST information is missing from the input data, a typical time value may be used by using content information of schedules and events. For example, even if there is no direct content for an ST value in denormalized input data of “Gangnam Station, Restaurant A, 2:00, Lunch Appointment”, the information “Lunch Appointment” may be used to set the ST value typically to 1 hour (60 minutes). The content information of the schedules and the events and typical time values corresponding to the corresponding information may also be retrieved and applied by using the databases generated in advance.

When the event information or the basic information is created in the form of image information or video information, the schedule analysis unit 320 may analyze metadata included in the image information or the video information to extract at least one of capturing date information, capturing time information, and capturing location information so as to assign a result of the extraction as the probability factor information.

In this case, the metadata is structured data for other data, and may be also referred to as data that describes other data, that is, attribute information. Denormalized image and video files captured by a digital device all have the metadata, and the metadata may include information on a capturing date, a capturing time, and a capturing location (latitude and longitude) of an image and a video.

In this case, latitude and longitude values may be AR, the capturing date may be DA, and AT may range from −10 minutes from the capturing time to the capturing time, and a value between 1 minute and 10 minutes, which is a typical time required for capturing the image and the video, may be applied to ST.

If multiple images having the same AR and DA values are input, the input images may be recognized as one piece of event information. In this case, a value ranging from −10 minutes from the earliest time among the capturing times of the input images to the capturing time may be applied to AT, and a value obtained by subtracting the earliest time among the capturing times of the input images from the latest time among the capturing times of the input images may be applied to ST.

The schedule analysis unit 320 may derive factor information for calculating a probability, such as the place (AR), the date (DA), the arrival time (AT), and the stay time (ST), by using the basic information about the daily life pattern of the user.

For example, when assuming that there is information such as a home address, a company address, a commuting method, and a commuting time, the user rides on a bus from a home to a company, a travel time is 30 minutes, and an attendance time is 9:00, the encountering probability may be calculated by applying factors such that the closest bus stop to the home is AR, a time to arrive at the bus stop in consideration of the travel time is 8:10˜8:20, which is AT, and ST is 10 minutes.

In addition, the encountering probability may be displayed without performing geometric probability calculation by using the basic information. For example, a coworker in the same workplace may be recognized by using the basic information, and it is possible to obtain a result that a probability of encountering the coworker is 99% or more during normal workdays (weekdays).

In addition, assuming that transportation is the bus, the shortest travel path for traveling from the home address to the company address may be estimated, and a lapse time from a departure time to an arrival time may be calculated by using travel time information derived from the estimated shortest travel path so as to estimate the arrival time zone. In addition, in a limited place such as the bus, the travel time may be regarded as the stay time, so that the travel time information depending on the transportation may be used as information on the stay time.

The probability calculation unit 330 may calculate the encountering probability between at least two users by using the probability factor information derived through the schedule analysis unit 320.

When pieces of the probability factor information of the users about the place and the date are identical to each other, the probability calculation unit 330 may calculate the encountering probability among the users by analyzing geometrically-overlapping regions by using the arrival time zone and the stay time of each user.

The geometric probability is a concept that may be applied when the probability may not be determined by a ratio of numbers because the number of cases may not be counted. For example, when two people make an appointment between 1:00 and 2:00, and the probability of arrival of the other party after 1:30 is calculated, if it is assumed that the probability of arrival of the other party is the same at each time between 1:00 and 2:00, the probability may be represented by (time after 1:30)/(time between 1:00 and 2:00). However, the difficulty in this case is that while the time is unique, it is impossible to count all subdivided times such as 1:40:1, 1:40:01, and 1:40:001 which are times near 1:40.

Therefore, in this case, the probability may be replaced by a ratio of length on a time line occupied by the corresponding region. Since a total is 60 minutes, and the corresponding case is 30 minutes, the probability may be calculated by (30 minutes/60 minutes)=(½). The ratio of length is one example, and a ratio of area or a ratio of volume may be applicable in the same logic.

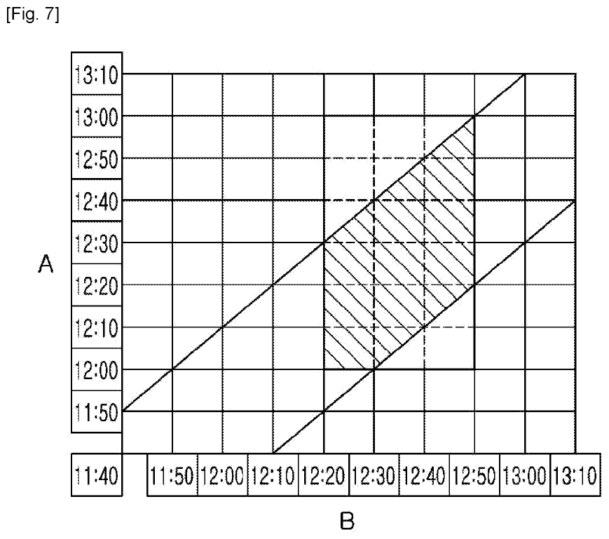

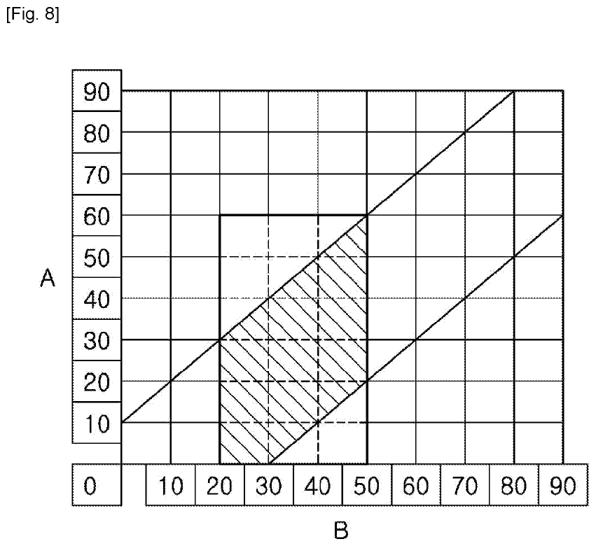

The encountering probability will be described in more detail with reference to FIGS. 7 and 8.

In order to obtain the encountering probability between two people, first, the arrival time (AT) and the stay time (ST) at the same place (AR) are required. For example, it is assumed that “on the same day at the same place, A has a schedule for arriving between 12:00 and 1:00 to stay for 30 minutes, while B has a schedule for arriving between 12:20 and 12:50 to stay for 10 minutes.”

Then, a graph as shown in FIG. 7 may be drawn, in which a Y-axis time domain and a solid line graph are time lines of A, and an X-axis time domain and a dotted line graph are time lines of B. Since times of the two people always increase equally, it is meaningless to start from 11:40 at a lower portion. Even if the graph is drawn from 11:30 or 11:20, the graph will be drawn to have the same shape, eventually. Therefore, for convenience of calculating a formula, when the graph is drawn while assuming 12:00 as 0, the result may be illustrated as in FIG. 8.

In this case, since A has the schedule of staying for 30 minutes, the time line has to be drawn after adding 30 minutes in the time domain of the other party, that is, the time domain of B. In other words, it gradually increases after starting from 30 in the X-axis and 0 in the Y-axis.

Since B has the schedule of staying for 10 minutes, the time line has to be drawn after adding 10 minutes in the time domain of the other party, that is, the time domain of A. In other words, it gradually increases after starting from 0 in the X-axis and 10 in the Y-axis.

A total encountering probability of A and B may be expressed as an area of the time domain where each person may arrive. In this case, the encountering probability (number of cases) may be an area of an inner region between the two time lines in the corresponding time domain area.

In other words, a hatched portion of a rectangular region in FIG. 8 may be the encountering probability of the two people. In this case, since an area of the hatched region may be obtained by subtracting areas of two triangles (portions except for the hatched region) from an area of a rectangle, the area of the hatched region may be calculated by the following formula, and eventually, the encountering probability of the two people may be 63.88%.

$$\frac{area of rectangle \cdot ( areas of two triangles )}{area of rectangle} = \frac{30 \times 60 - ( ( 20 \times 20 \times \frac{1}{2} ) + ( 30 \times 30 \times \frac{1}{2} ) )}{30 \times 60} = \frac{23}{36} = 63.88 \%$$

The probability calculation unit 330 may transmit the encountering probability calculated through the above process to a smart device of the user or the like through the communication unit 340. The users who receive the encountering probability may receive information on new social relations which have not been provided by the existing SNS. As a result, by the medium of information that is the encountering probability, a social relation network may be formed with many unspecified people or acquaintances well known by the user, and a social relation network may be formed with people close to the user.

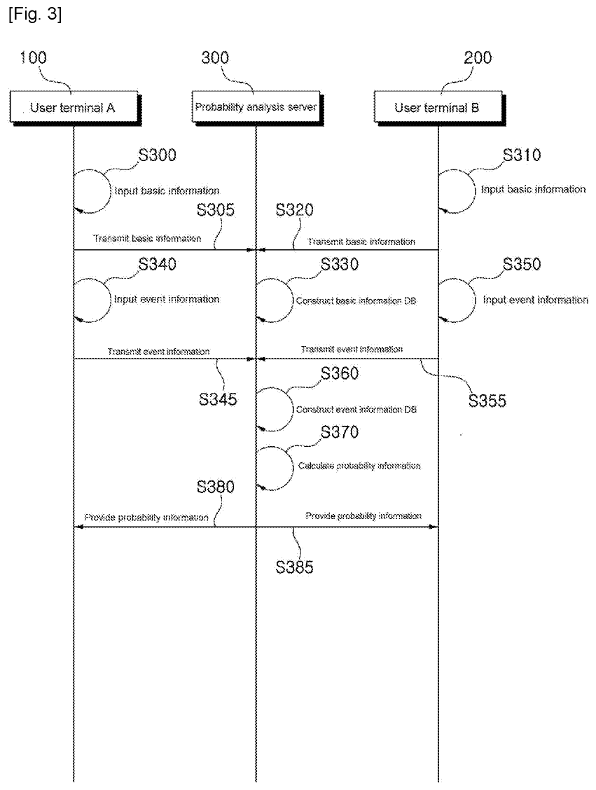

FIGS. 3 to 6 are flowcharts showing processes of a method for providing a probability of encountering other people according to an embodiment of the present invention.

The method for providing the probability of encountering other people according to an embodiment of the present invention will be described as follows.

First, at least two users may input basic information corresponding to daily information into a user terminal A 100 and a user terminal B 200 (S300 and S310), and the input basic information may be transmitted to the probability analysis server 300 through the online network (S305 and S320).

The probability analysis server 300 may construct a database by classifying the received basic information of each user according to a user account (S330).

Thereafter, the users may respectively input event information corresponding to special daily information into the user terminal A 100 and the user terminal B 200 (S340 and S350), and the input event information may be transmitted to the probability analysis server 300 (S345 and S355).

The probability analysis server 300 may construct a database by classifying the received event information of each user according to the user account (S360).

Thereafter, the probability analysis server 300 may extract the probability factor information by analyzing the stored basic information or event information, and may calculate the encountering probability of the two people by analyzing the probability factor information in a geometric manner (S370). Then, the probability analysis server 300 may provide the calculated encountering probability to each of the user terminals 100 and 200 (S380 and S385).

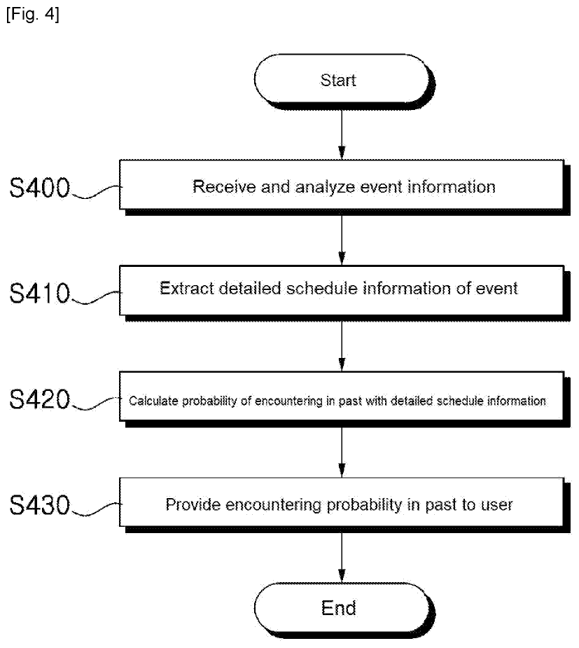

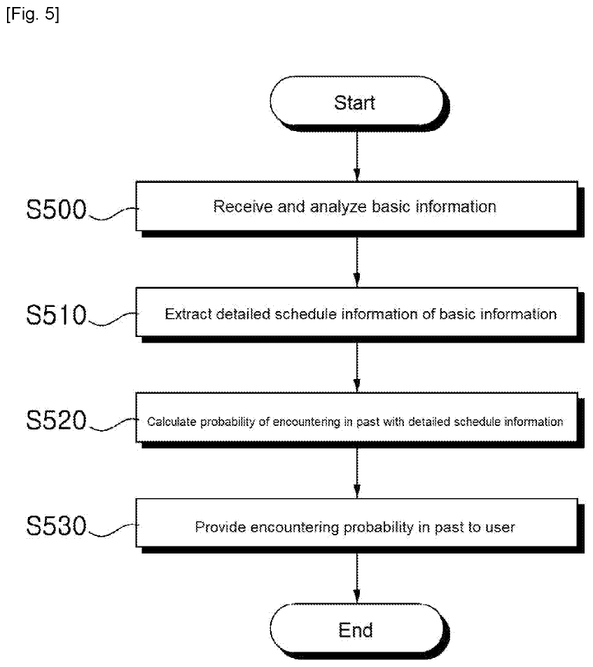

The process after step S370 will be described in more detail with reference to FIGS. 4 and 5.

FIG. 4 is a flowchart showing a process of deriving the probability of encountering other people by using event information according to an embodiment of the present invention.

The probability analysis server 300 may receive the event information provided from the user terminal and analyze the received event information (S400). In this case, the event information may include text information, image information, or video information.

Thereafter, the probability analysis server 300 may extract the time information and the space information of each user according to the information extracting algorithm, and may generate the probability factor information in terms of the place, the date, the arrival time zone, and the stay time (S410).

In this case, when the event information is denormalized text information, the schedule analysis unit 300 may divide the denormalized text information in a unit of a predetermined size of strings or words to extract a sequence value for each unit, and may analyze each of the extracted sequence values to assign a result of the analysis as the probability factor information.

Meanwhile, when the event information is the image information or the video information, the schedule analysis unit 300 may analyze metadata included in the image information or the video information to extract at least one of capturing date information, capturing time information, and capturing location information so as to assign a result of the extraction as the probability factor information.

Thereafter, the probability analysis server 300 may calculate an encountering probability between two users by determining an overlapping degree of the probability factor information of the two users (S420).

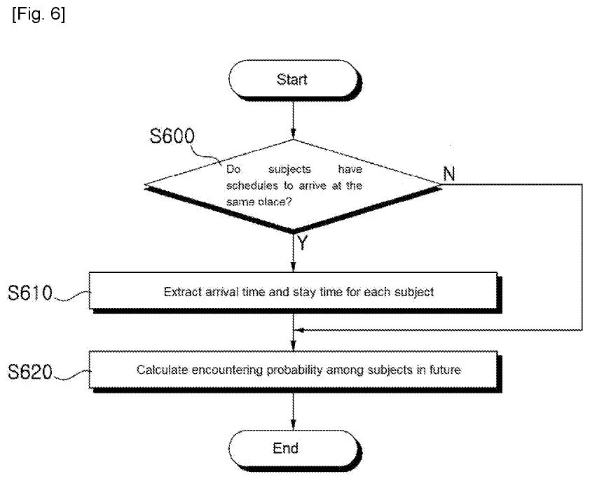

A process of calculating the encountering probability will be described in more detail with reference to FIG. 6.

The probability analysis server 300 may analyze the probability factor information classified into the place, the date, the arrival time zone, and the stay time to verify whether subjects who intend to calculate the encountering probability have the same probability factor information regarding the place and the date (S600).

If it is determined that the subjects do not exist in the same place, or the subjects do not exist on the same date even when being in the same place, the encountering probability of the subjects may be calculated as 0 (S620).

If the subjects exist in the same place on the same date, the probability factor information of each of the subjects about the arrival time zone and the stay time may be extracted (S610).

Thereafter, the encountering probability of the subjects may be calculated by using the extracted probability factor information on the arrival time zone and the stay time (S620).

Referring again to FIG. 4, the calculated information about the encountering probability may be provided to each user (S430).

FIG. 5 is a flowchart showing a process of deriving the probability of encountering other people by using basic information of a user according to another embodiment of the present invention.

The probability analysis server 300 may receive the basic information provided from the user terminal and analyze the received basic information (S500). Unlike the event information described above, the basic information refers to information about the daily life pattern that occurs regularly. For example, the basic information may include information that may be applied to the user on a daily basis, such as the home address, the company name, the company address, the work department, the commuting time, the commuting method, the school name, the academic department, the school commuting time, and the school commuting method.

Then, the probability analysis server 300 may extract detailed schedule information from the basic information (S510). For example, it is assumed that there is information such as the home address, the company address, the commuting method, and the commuting time. When assuming that the user rides on a bus from a home to a company, a travel time is 30 minutes, and an attendance time is 9:00, the closest bus stop to the home may be assigned as the probability factor information about the place, a time to arrive at the bus stop in consideration of the travel time, which is 8:10˜8:20, may be assigned as the probability factor information about the arrival time zone, and a basic dispatch time of the bus, which is 10 minutes, may be assigned as the probability factor information about the stay time. The probability factor information may be regularly generated every time during a period of time except holidays or national holidays, and may be applied to the school commuting for schools as well as the company.

Thereafter, the probability analysis server 300 may calculate an encountering probability between two users by determining an overlapping degree of the probability factor information of the two users (S520), and the calculated information about the encountering probability may be provided to each user (S530).

Embodiments according to the present invention described above may be implemented in the form of program commands that may be executed through various computer components, and may be recorded in a computer-readable recording medium. The computer-readable recording medium may include program commands, data files, data structures, and the like, alone or in combination. The program commands recorded in the computer-readable recording medium may be those specially designed and configured for the present invention, and may be those known and available to a person having ordinary skill in the art of computer software. Examples of the computer-readable recording medium include hardware devices specially configured to store and execute program commands, such as magnetic media such as hard disks, floppy disks, and magnetic tapes, optical recording media such as CD-ROMs and DVDs, magneto-optical media such as floptical disks, ROMs, RAMs, and flash memories. Examples of the program commands include machine code generated by a compiler as well as high-level language code that can be executed by a computer using an interpreter or the like. The hardware devices may be configured to operate as one or more software modules to perform a process according to the present disclosure, or vice versa.

Although the embodiments of the present invention have been described above, it is to be understood by a person with ordinary skill in the art to which the present invention pertains that various modifications may be made without departing from the scope of the claims of the present invention.

### INDUSTRIAL APPLICABILITY

According to the present invention, the social relation network can be formed with people close to a user in time and space

In addition, according to the present invention, unlike the existing SNS, it is possible to bring about creation, expansion, strengthening, and maintenance of social relations in a new field of interest, and furthermore, alternatives to social opinion formation, expansion of information exchange means, global relation, sharing, communication, cooperation, and the like can be achieved.

1. A server for providing a probability of encountering other people, the server comprising:
a user information database unit for storing at least one of a text, a photograph, and a video uploaded to an SNS(Social Network Service) system as event information for each user in association with the SNS system;
a schedule analysis unit for analyzing the event information to extract a target place of each user, a date, an arrival time zone for the place, and a stay time at the place depending upon an information extracting algorithm so as to generate probability factor information; and
a probability calculation unit for calculating an encountering probability among users by determining an overlapping degree of the probability factor information of the users.

2. The server of claim 1, wherein the event information includes at least one of text information, image information, and video information.

3. The server of claim 2, wherein, when the event information is denormalized text information, the schedule analysis unit divides the denormalized text information in a unit of a predetermined size of strings or words to extract a sequence value for each unit, and analyzes each of the extracted sequence values to assign a result of the analysis as the probability factor information.

4. The server of claim 2, wherein, when the event information is the image information or the video information, the schedule analysis unit analyzes metadata included in the image information or the video information to extract at least one of capturing date information, capturing time information, and capturing location information so as to assign a result of the extraction as the probability factor information.

5. The server of claim 1, wherein, when pieces of the probability factor information of the users about the place and the date are identical to each other, the probability calculation unit calculates the encountering probability among the users by analyzing geometrically-overlapping regions by using the arrival time zone and the stay time of each user.

6. A server for providing a probability of encountering other people, the server comprising:
a user information database unit for storing basic information provided to an SNS (Social Network Service) system in association with the SNS system;
a schedule analysis unit for analyzing the basic information to extract regular time information and regular space information of each user depending upon an information extracting algorithm so as to generate probability factor information; and
a probability calculation unit for calculating an encountering probability between two users by determining an overlapping degree of the probability factor information of the two users,
wherein the basic information includes information on two places which are target places to go repeatedly at least two times within a predetermined period of time, departure/arrival time information, and transportation information.

7. The server of claim 6, wherein the schedule analysis unit analyzes the basic information to generate the probability factor information in terms of the place, the date, the arrival time zone, and the stay time, and estimates the arrival time zone and the stay time based on the transportation information included in the basic information.

8. The server of claim 7, wherein, when pieces of the probability factor information of the users about the place and the date are identical to each other, the probability calculation unit calculates the encountering probability among the users by analyzing geometrically-overlapping regions by using the arrival time zone and the stay time of each user.

9. A server for providing a probability of encountering other people, the server comprising:
a user information database unit for storing at least one of a text, a photograph, and a video uploaded to an SNS(Social Network Service) system as event information for each user in association with the SNS system, and storing basic information provided from a user terminal for each user;
a schedule analysis unit for analyzing the event information to extract a target place of each user, a date, an arrival time zone for the place, and a stay time at the place in a past depending upon an information extracting algorithm so as to generate probability factor information, or analyzing the basic information to extract a target place of each user, a date, an arrival time zone for the place, and a stay time at the place in a future depending upon the information extracting algorithm so as to generate the probability factor information; and
a probability calculation unit for calculating an encountering probability among users in a past by determining an overlapping degree of the probability factor information generated based on the event information of the users, or calculating an encountering probability among users in a future by determining an overlapping degree of the probability factor information generated based on the basic information of the users,
wherein the basic information includes information about a daily life pattern of each user that occurs regularly.
